(19) United States
(12) Patent Application Publication
(10) Pub. No.: US 2026/0357858 A1
(43) Pub. Date: Nov. 12, 2026

(54) Brake Caliper

(71) Applicant: BREMBO N.V., Bergamo (IT)

(72) Inventor: Alessandro SACELLA, Bergamo (IT)

(21) Appl. No.: 19/669,147

(22) Filed: May 6, 2026

(30) Foreign Application Priority Data
May 6, 2025 (IT) 102025000010035

(51) Int. Cl. F16D 55/2265; F16D 55/00; F16D 65/00

(52) U.S. Cl. CPC F16D 55/2265; F16D 65/0068; F16D 2055/0016; F16D 2055/007

(57) ABSTRACT

It is the object of the present invention a brake caliper 1 for a disc brake, comprising a fixed portion 2, at least one brake pad 3, 3′, at least one support pin 10, 10′, a retaining spring 4, wherein the retaining spring 4 is interposed between the fixed portion 2 and the at least one brake pad 3, 3′ to elastically bias at least radially along a direction parallel to the radial direction R-R with a radial elastic action the at least one brake pad 3, 3′ abutting against the at least one support pin 10, 10′, wherein the fixed portion 2 comprises a disc inlet backing surface 12 and a disc outlet backing surface 13 on tangentially opposite sides along the tangential direction T-T, wherein the at least one brake pad 3, 3′ comprises a plate 7 and a pad friction material 8 supported by the plate 7, wherein the plate 7 comprises a plate edge 15 delimiting the plate 7 between a first plate face 16 and a second plate face 17 axially opposite to each other along the axial direction A-A, wherein the plate 7 comprises a disc inlet pad abutment surface 18 and a disc outlet pad abutment surface 19 on tangentially opposite parts along the tangential direction T-T, wherein the disc inlet pad abutment surface 18 comprises a radially inner disc inlet portion 22 and a radially outer disc inlet portion 23, wherein the disc outlet pad abutment surface 19 comprises a radially inner disc outlet portion 24 and a radially outer disc outlet portion 25, wherein the pad plate 7 comprises a pin seat 20, wherein the pin seat 20 abuts against the support pin 10, 10′ at least along a direction parallel to the radial direction R-R against the radial elastic bias of the at least one retaining spring 4, wherein the retaining spring 4 biases the plate edge 15 at a thrust distance D1, D2 with respect to the pin axis E, E′ of the support pin 10, 10′ so as to constantly bias the brake pad 3, 3′ in rotation about the pin axis E, E′ of the support pin 10, 10′ towards a resting configuration, wherein, in the resting configuration, the brake pad 3, 3′ abuts at least radially against the support pin 10, 10′ with the pin seat 20, and the brake pad 3, 3′ abuts at least along the tangential direction T-T on one side against the disc outlet backing surface 13 with the disc outlet radially inner portion 24 of the disc outlet pad abutment surface 19, and on the opposite side against the disc inlet backing surface 12 with the disc inlet radially outer portion 23 of the disc inlet pad abutment surface 18, wherein the at least one brake pad 3, 3′ is supported along the radial direction R-R or directions parallel thereto by only one of said at least one support pin 10, 10′, wherein the brake caliper 1 comprises a pad return device 9, in forward motion, the brake pad 3, 3′ is dragged by the brake disc 5 from the resting configuration to a forward motion braking configuration, rotating against the radial elastic action of the retaining spring 4 about the support pin 10, 10′ and translating at least along the tangential direction T-T sliding on the support pin 10, 10′ and along the radial direction R-R sliding on the disc outlet backing surface 13.

### CROSS-REFERENCE TO RELATED APPLICATIONS

This application claims the priority benefit of Italian Pat. App. No. 102025000010035 filed on May 6, 2026, the contents of which are hereby incorporated by reference in the entirety.

### FIELD OF THE INVENTION

The present invention relates to a brake caliper for a disc brake.

### BACKGROUND ART

In a brake caliper for a disc brake, an axial direction about which a brake disc rotates, a radial direction, substantially orthogonal to said axial direction, and a tangential direction, orthogonal to both said axial direction and said radial direction are defined.

Known brake calipers comprised a caliper body and/or a bracket or caliper carrier adapted to be arranged straddling the brake disc supporting in a sliding manner along the axial direction at least one brake pad adapted to engage a braking surface or band of the brake disc under a thrust action of a thrust device to cause the vehicle on which the brake caliper is installed to slow down.

The brake caliper defines a disc inlet side and disc outlet side, which are tangentially opposite, wherein, during a forward motion of the vehicle, the rotating brake disc enters from the disc inlet side and exits from the disc outlet side in the defined space of the caliper body arranged straddling the brake disc.

In some solutions, the caliper body comprises a disc outlet seat backing surface and a disc inlet seat backing surface on tangentially opposite sides, delimiting at least partially a pad seat configured to slidingly accommodate the at least one brake pad.

In the absence of a braking action, the at least one brake pad is radially supported on a pair of support pins comprising a disc inlet side pin and a disc outlet side pin, wherein the brake pad is constantly elastically biased in the radial direction by a retaining and positioning spring abutting on the support pins.

During a braking action, the brake pad initially slides in the axial direction from a resting position toward the brake disc, supported on the support pins, until contacting the brake disc, and the brake disc drives the brake pad in the tangential direction, and the brake pad slides tangentially supported on the support pins until it abuts against the disc outlet seat backing surface in a forward motion braking action, or against the disc inlet seat backing surface during a reverse motion braking action, generating a clang noise, and discharging the braking force onto the caliper body.

This clang noise may be very annoying and the need to avoid or reduce or eliminate it as far as possible is strongly felt in the field.

Furthermore, it may happen that, while traveling, the at least one brake pad, supported on the support pins, may oscillate tangentially due to the vibrations of the vehicle generating a rattling noise, such as jingling or clanking, which may be repetitive, e.g., due to the contact between the brake pad plate and the caliper body.

This rattling noise also may be very annoying and the need to avoid or reduce or eliminate as far as possible is strongly felt in the field.

At present, to reduce or eliminate the onset of this clang noise, it is provided to use a rubberized metal shim which covers the pad plate on the side in which it contacts the thrust device or piston, and is folded covering the shoulders of the brake pad thus attenuating and damping the clang noise. However, the use of shims is not suited to be employed in some solutions in which the friction between the piston and the pad is reduced, and in such cases one is obliged to employ double-sided adhesive between the shim and the piston, which may degrade at high temperatures and entails a significant increase in costs.

A known solution for reducing rattling noise is that of document U.S. Pat. No. 3,893,547A, wherein the brake pad plate comprises a first pin seat and a second pin seat, wherein the first pin seat and the second pin seat accommodate a first support pin and a second support pin, wherein a retaining spring or radial spring is interposed between the caliper body and the brake pad plate, contacts the plate at a central position with respect to the first pin seat and the second pin seat and bias the brake pad in the radial direction so that, in the absence of a braking action, the first pin radially abuts against the first pin seat, the second pin avoids abutting against the second pin seat, and the brake pad is rotated about the first pin, abutting on tangentially opposite parts of the plate against the disc inlet seat backing surface and against the outlet seat backing surface, without coming into contact with or being obstructed by the second pin. Furthermore, in this solution, the second pin seat comprises at least one abutment surface which abuts against the second pin during a braking action, preventing the plate of the brake pad from abutting against the caliper body and completely discharging the braking force directly onto the caliper body.

In this solution, although satisfactory in some respects, during the braking action in one of the two motions, the brake pad rotates on the contact zone of the caliper body until it abuts against the second pin, generating a clang noise and discharging the braking force onto one of the two pins. On one hand, this solution does not prevent the generation of clang noises and, on the other, there is a concentration of strains localized on the second pin, which may not be acceptable in some very severe braking conditions.

A solution for reducing clang noises is known from JP2006207655, in which the brake pad is radially supported by a single brake pad support pin, wherein a radial positioning spring is mounted on the pin, partially wound around the pin and has two spring arms, which bias the pad plate in the radial direction at two side positions spaced apart with respect to the pin by a first lateral distance and a second lateral distance, which are mutually different so as to rotationally bias the brake pad, tilting it and abutting, at tangentially opposite sides, against the disc inlet seat backing surface and against the disc outlet seat backing surface. This solution may allow a partial reduction of clang noises with respect to the solution of the document U.S. Pat. No. 3,893,547A, however, the radial positioning spring is mounted on the pin, and in the event of very high braking forces and accelerations, the radial positioning spring may rotate integrally with the brake pad during braking generating rattling noise.

Therefore, the need remains to achieve brake caliper solutions which make it possible to limit or eliminate the onset of clang noise and, at the same time, contain or limit the onset of rattling noise.

Furthermore, once the braking action has ended, the brake pad may remain in contact with the braking surface, generating residual torque.

Therefore, a need is strongly felt in the field to provide brake calipers which make it possible to reduce the onset of clanging noises and rattling noises, and, at the same time, reduce or eliminate any residual torques between the brake pad and the brake disc once the braking action has ended.

Therefore, the problem underlying the present invention is to devise a brake caliper, which has structural and functional features such to satisfy the aforementioned requirements and, at the same time, solve the drawbacks mentioned with reference to the prior art.

### SOLUTION

It is the object of the present invention to provide a brake caliper for a disc brake.

These and other objects and advantages are achieved with a brake caliper according to claim 1.

Other advantageous embodiments are the object of the dependent claims.

An analysis of this solution has shown that the suggested solution makes it possible to reduce the residual torque at the end of the braking action, and to reduce the clang noises and the rattling noises.

### FIGURES

Further features and advantages of the brake caliper will become apparent from the description provided below of preferred exemplary embodiment thereof, given by way of non-limiting example, with reference to the accompanying drawings, in which:

FIG. 1 shows a brake caliper according to the present invention, in which the brake caliper comprises a pair of brake pads, axially opposite to each other so as to clamp the brake disc from axially opposite sides, wherein each brake pad is supported by a single support pin, wherein each brake pad is radially biased by a retaining spring toward a resting configuration, in which the brake pad is in equilibrium, rotated about the support pin, in contact in three zones, with the support pin, and with the fixed portion of the brake caliper, in this case the caliper body, on tangentially opposite sides;

FIG. 2 shows a section view taken along a plane perpendicular to the axial direction of the brake caliper of FIG. 1, in which a brake pad is in the resting configuration, supported on the support pin in a radially outer position with respect to the rotation axis of the brake disc, supported at tangentially opposite sides against the fixed portion of the brake caliper, in this case the caliper body, in particular against the disc outlet backing surface, on the left, and against the disc inlet backing surface on the right;

FIG. 3 shows a section view taken along a plane perpendicular to the tangential direction of the brake caliper of FIG. 1, in which some parts of the brake caliper have been omitted so as to display the two brake pads and the pad spring configured to bias the brake pads in the radial direction and in the axial direction away from each other, wherein the pad spring comprises the retaining spring and the pad return device;

FIG. 4 shows a detail of FIG. 2, so as to display that the brake pad is abutting against the disc outlet backing surface of the fixed portion of the brake caliper, in this case the caliper body, in a radially inner position, tangentially defining a gap between the disc outlet backing surface and the disc outlet abutment surface of the brake pad, which is radially open on the side opposite to the brake disc and is radially closed on the side toward the brake disc;

FIG. 5 shows a detail of FIG. 2, so as to display that the brake pad is abutting against the disc inlet backing surface of the fixed portion of the brake caliper, in this case the caliper body, in a radially outer position, tangentially defining a gap between the disc inlet backing surface and the disc inlet abutment surface of the brake pad, which is radially open on the side toward the brake disc and is radially closed on the side opposite to the brake disc;

FIG. 6 diagrammatically shows the brake pad of the brake caliper according to the present invention in the resting configuration, biased by the spring radially elastically in the resting configuration;

FIG. 7 diagrammatically shows the brake pad of the brake caliper according to the present invention at the beginning of a forward motion braking action, in which the tangential braking force of the brake disc which biases the brake pad toward the forward motion braking configuration in opposition to the action of the spring is shown;

FIG. 8 diagrammatically shows the brake pad of the brake caliper according to the present invention during a steady-state forward motion braking action, in which the brake pad is in the forward braking configuration, in which the braking force is mainly discharged onto the disc outlet backing surface, without contacting the disc inlet backing surface;

FIG. 9 diagrammatically shows the brake pad of the brake caliper according to the present invention at the beginning of a reverse motion braking action, in which the tangential braking force of the brake disc which biases the brake pad toward the reverse motion braking configuration in opposition to the action of the spring is shown;

FIG. 10 diagrammatically shows the brake pad of the brake caliper according to the present invention during a steady-state reverse motion braking action, in which the brake pad is in the reverse braking configuration, in which the braking force is mainly discharged onto the disc inlet backing surface, without contacting the disc outer backing surface;

FIG. 11 diagrammatically shows the brake pad of the brake caliper according to the present invention in the resting configuration, biased by the spring radially elastically in the resting configuration, in which the spring biases the brake pad radially in a single zone at a thrust distance from the support pin, and wherein the pin seat is formed by an appendage of the plate of the brake pad which forms a seat open tangentially on one side and closed on the other.

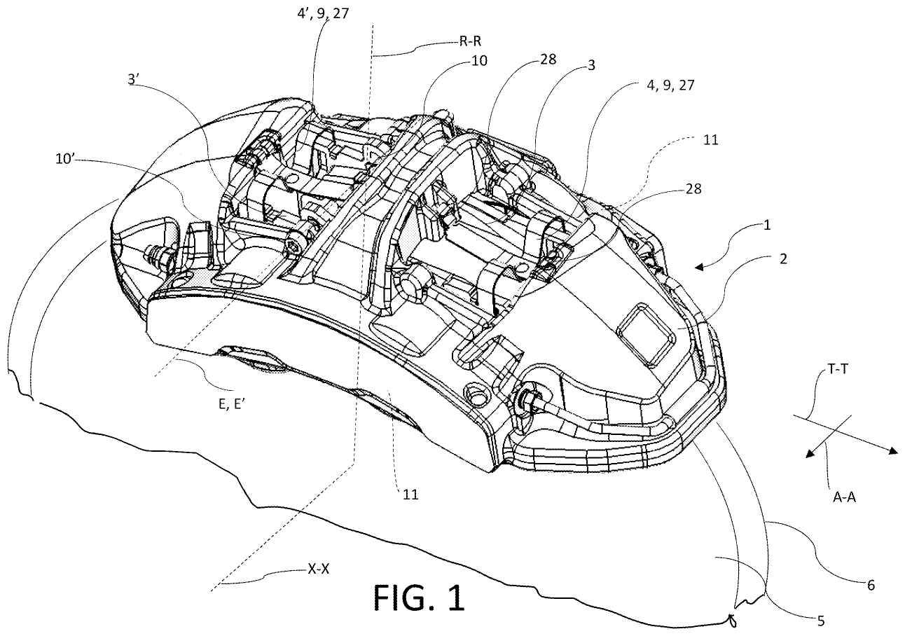

### DESCRIPTION OF SOME PREFERRED EMBODIMENTS

According to a general embodiment, a brake caliper for a disc brake is provided, generally designated by reference numeral 1. In an embodiment, the brake caliper is of the fixed brake caliper type. In an embodiment, the brake caliper is of the floating brake caliper type.

The brake caliper 1 defines an axial direction A-A, a radial direction R-R perpendicular to the axial direction A-A, and a tangential direction T-T perpendicular to both said axial direction A-A, and said radial direction R-R.

The brake caliper 1 comprises a fixed portion 2. Fixed portion 2 means a portion of the brake caliper 1 which can be constrained to a hub carrier of a suspension of a vehicle, so that the brake caliper remains suspended above the brake disc. In brake calipers of the fixed brake caliper type, the fixed portion 2 is a caliper body. In brake calipers of the floating brake caliper type, the brake caliper comprises the fixed portion 2 and a floating caliper body, wherein the fixed portion 2 is a support bracket or caliper carrier, and wherein the floating caliper body is connected to the fixed portion so as to translate along a direction parallel to the axial direction A-A on respective guide pins.

The fixed portion 2, e.g., the caliper body or the support bracket, is configured to be arranged straddling a brake disc 5, wherein said brake disc 5 has a rotation axis X-X about which it rotates, wherein the axial direction A-A is parallel to the rotation axis X-X, wherein the radial direction R-R is perpendicular to the rotation axis X-X.

The brake caliper 1 comprises at least one brake pad 3, 3′.

The brake caliper 1 comprises at least one support pin 10, 10′.

The support pin 10, 10′ is mounted on the fixed portion 2, e.g., the caliper body or the support bracket, along a direction parallel to the axial direction A-A, e.g., press-fitted or screwed to the fixed portion 2, e.g., the caliper body or the support bracket, wherein each support pin 10, 10′ has a respective pin axis E, E′, parallel to the axial direction A-A, wherein the at least one support pin 10, 10′ is configured to support the at least one brake pad 3, 3′ abutting at least along the radial direction R-R or directions parallel thereto.

The brake caliper 1 comprises at least one retaining spring 4.

The retaining spring 4 is connected to the fixed portion 2, wherein the retaining spring 4 is interposed between the fixed portion 2, e.g., the caliper body or the support bracket, and the at least one brake pad 3, 3′ to elastically bias, at least radially along a direction parallel to the radial direction R-R with a radial elastic bias, the at least one brake pad 3, 3′ to abut against the at least one support pin 10, 10′.

The fixed portion 2, e.g., the caliper body or the support bracket, comprises a disc inlet backing surface 12 and a disc outlet backing surface 13 on tangentially opposite sides along the tangential direction T-T, delimiting a respective pad seat configured to receive the at least one brake pad 3, 3′.

The at least one brake pad 3, 3′ or each brake pad 3, 3′ comprises a plate 7 and a pad friction material 8 supported by the plate 7, wherein the friction material 8, 8′ is configured to abut against a braking surface 6 of the brake disc 5 to apply a braking action onto the brake disc 5, the at least one brake pad 3 being adapted to receive a thrust along the axial direction A-A, or a direction parallel thereto, from at least one thrust device 11. The at least one thrust device may be accommodated in the caliper body of the brake caliper of the fixed type or in the floating caliper body of the brake caliper of the floating type.

The plate 7 comprises a plate edge 15 delimiting the plate 7 between a first plate face 16 and a second plate face 17 axially opposite to each other along the axial direction A-A, wherein the friction material 8, 8′ is supported on the side of the first plate face 16.

The plate 7 and/or the plate edge 15 comprises a disc inlet pad abutment surface 18 and a disc outlet pad abutment surface 19 on tangentially opposite sides along the tangential direction T-T.

The disc inlet pad abutment surface 18 comprises a radially inner disc inlet portion 22 and a radially outer disc inlet portion 23.

The disc outlet pad abutment surface 19 comprises a radially inner disc outlet portion 24 and a radially outer disc outlet portion.

The pad plate 7 and/or the plate edge 15 comprises a pin seat 20, wherein the pin seat 20 abuts against the support pin 10, 10′ at least along a direction parallel to the radial direction R-R against the radial elastic bias of the at least one retaining spring 4.

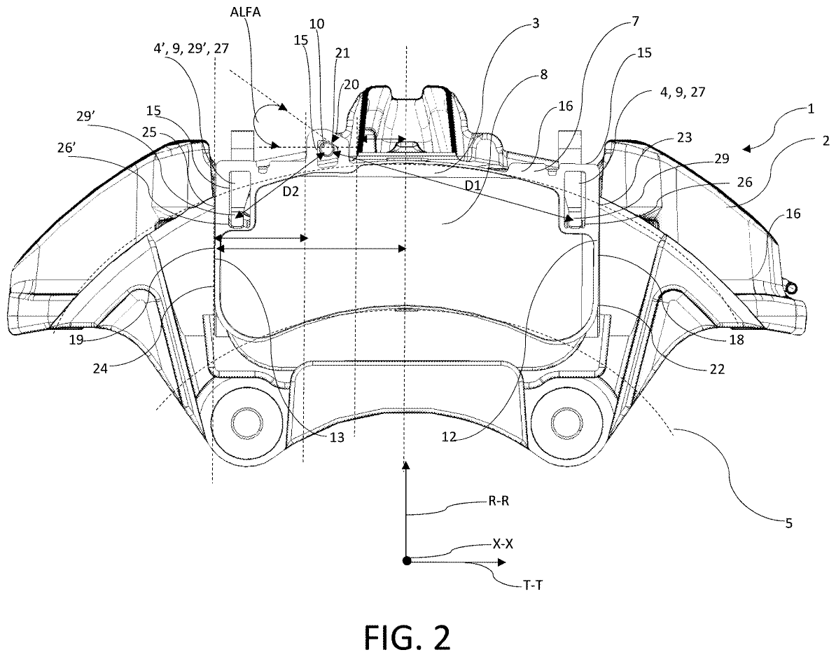

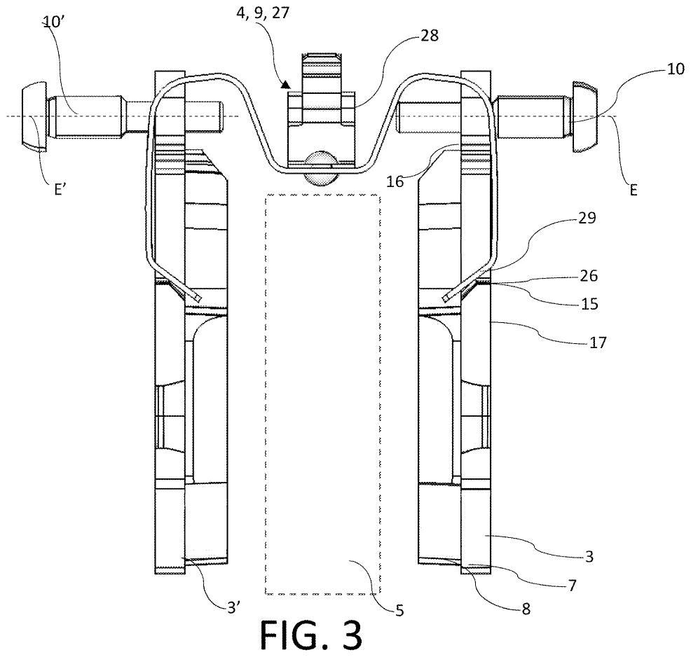

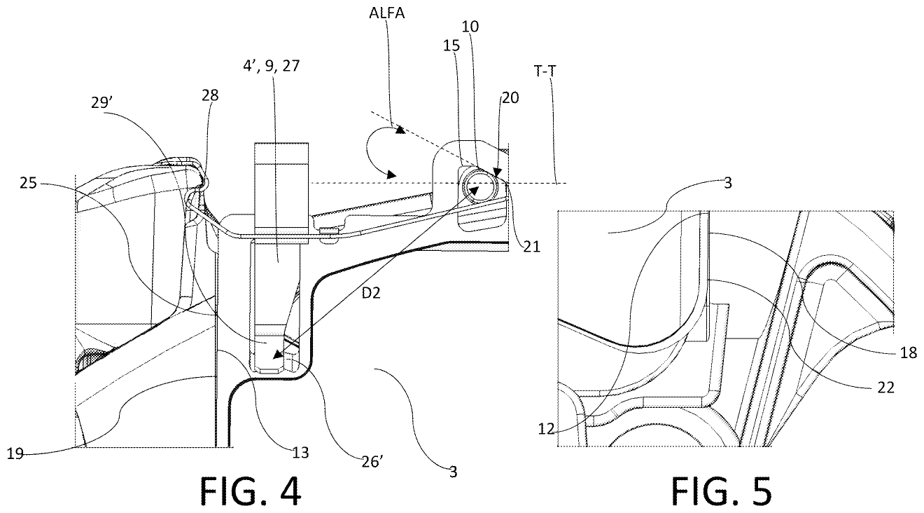

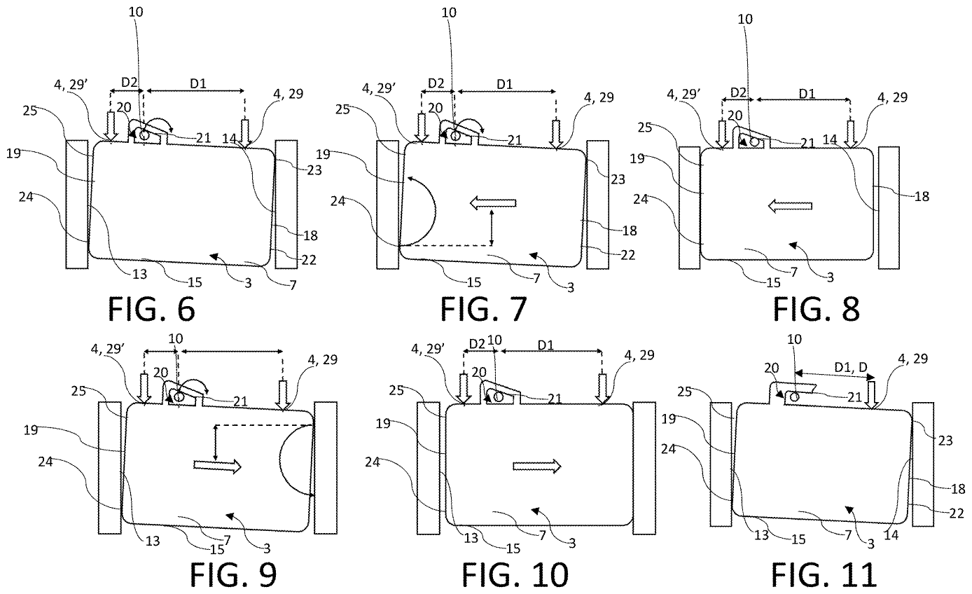

The retaining spring 4 biases the pad plate 7 and/or the plate edge 15 at a thrust distance D1, D2 with respect to the pin axis E, E′ of the support pin 10, 10′ so as to constantly bias the brake pad 3, 3′ in rotation about the pin axis E, E′ of the support pin 10, 10′ towards a resting configuration. For example, the resting configuration is shown in FIG. 2 and in FIG. 6, and in FIG. 11.

In the resting configuration, the brake pad 3, 3′ abuts at least radially against the support pin 10, 10′ with the pin seat 20.

In the resting configuration, the brake pad 3, 3′ abuts at least along the tangential direction T-T on one side against the disc outlet backing surface 13 with the disc outlet radially inner portion 24 of the disc outlet pad abutment surface 19, and on the opposite side against the disc inlet backing surface 12 with the disc inlet radially outer portion 23 of the disc inlet pad abutment surface 18, or vice versa.

Advantageously, the at least one brake pad 3, 3′ is supported along the radial direction R-R or directions parallel thereto by only one of said at least one support pin 10, 10′. In an embodiment, each brake pad 3, 3′ is supported along the radial direction R-R or directions parallel thereto by only one of said at least one support pin 10, 10′. In an embodiment, the brake caliper 1 comprises at least one pair of said at least one brake pad, axially opposite to each other so as to clamp the brake disc from axially opposite sides. In an embodiment, each brake pad of the pair of said at least one brake pad is supported by a single respective support pin. In an embodiment, a single support pin may be provided to support both brake pads of the pair of said at least one brake pad.

Advantageously, the brake caliper 1 comprises a pad return device 9.

The pad return device 9 is configured to constantly elastically bias the brake pad 3, 3′ at least along the axial direction A-A or directions parallel thereto, with orientation opposite to the brake disc. In an embodiment, the pad return device 9 is configured to constantly elastically bias the brake pad 3, 3′ at least along the axial direction A-A or directions parallel thereto against the thrust of the at least one thrust device 11 during the braking action and to retract from the braking surface 6 of the brake disc 5 upon cessation of the braking action.

During a braking action, in forward travel, the brake pad 3, 3′ is dragged and/or configured to be dragged by the brake disc 5, and or by the rotation of the brake disc 5, from the resting configuration to a forward travel braking configuration, against the radial elastic bias of the retaining spring 4. In an embodiment, during a braking action, in forward travel or in reverse travel, the at least one brake pad 3, 3′ initially slides in the axial direction either directly or indirectly under the thrust of the at least one thrust device 11, toward the brake disc against the axial elastic bias of the pad return device 9, maintaining the resting configuration under the radial elastic action of the retaining spring 4, i.e., at least radially abutting against the support pin 10, 10′ and at least tangentially abutting on one side against the disc outlet backing surface 13 and on the other against the disc outlet backing surface 13, or vice versa, until contacting the brake disc. When the brake pad 3, 3′ in the resting configuration contacts the brake disc under the direct or indirect thrust of the at least one thrust device 11, the disc drives the brake pad in tangential direction toward the braking configuration in forward travel or the braking configuration in reverse travel. In an embodiment, during a braking action, in forward motion, the brake pad 3, 3′ is dragged and/or configured to be dragged by the brake disc 5 from the resting configuration to a forward motion braking configuration, rotating against the radial elastic bias of the retaining spring 4 about the support pin 10, 10′ and translating at least along the tangential direction T-T sliding on the support pin 10, 10′ and along the radial direction R-R sliding on the disc outlet backing surface 13. In an embodiment, the brake pad 3, 3′ under the driving action of the brake disc 5 is configured to rotate against the radial elastic bias of the retaining spring 4 about the support pin 10, 10′ and to translate at least along the tangential direction T-T sliding on the support pin 10, 10′ and along the radial direction R-R sliding on the disc outlet backing surface 13, passing from the resting configuration to the forward motion braking configuration. The forward motion braking configuration is shown, for example, in FIG. 8.

In the forward motion braking configuration, the brake pad 3, 3′ abuts against the support pin 10, 10′ at least along the radial direction R-R, the brake pad 3, 3′ abuts along the tangential direction T-T against the disc outlet backing surface 13 with the radially inner disc outlet portion 24 and with the radially outer disc outlet portion 25 of the disc outlet pad abutment surface 19, the brake pad 3, 3′ faces the disc inlet backing surface 12 with the disc inlet pad abutment surface 18 without contact, discharging the braking action tangentially at least against the disc outlet backing surface 13. In an embodiment, the support pin 10, 10′ comprises a curved portion on which the brake pad 3, 3′ abuts in the resting configuration, and on which it rotates in abutment while passing from the resting configuration to the braking configuration, in forward motion or in reverse motion. The curved portion is, for example, a portion at least partially cylindrical or entirely cylindrical, as shown in the figures.

In an embodiment, the retaining spring 4 is interposed between the fixed portion 2, e.g. the caliper body or the support bracket, and the at least one brake pad 3, 3′ without contacting the support pin 10, 10′. By virtue of the provision of springs which generate the radial load, which are fixed to the fixed portion of the brake caliper, e.g., the caliper body or the support bracket, instead of to the pin of the pad, it is possible, even in the presence of high forces, that the springs do not revolve integrally with the pad, contributing to reducing or eliminating rattling noise.

In an embodiment, during a braking action, in reverse motion, the brake pad 3, 3′ is dragged and/or configured to be dragged by the brake disc 5 from the resting configuration to a reverse motion braking configuration, rotating against the radial elastic bias of the retaining spring 4 about the support pin 10, 10′ and translating at least along the tangential direction T-T sliding on the support pin 10, 10′ and along the radial direction R-R sliding on the disc inlet backing surface 12. The reverse motion braking configuration is shown, for example, in FIG. 10.

In an embodiment, in the reverse motion braking configuration, the brake pad 3, 3′ abuts against the support pin 10, 10′ at least along the radial direction R-R, the brake pad 3, 3′ abuts along the tangential direction T-T against the disc inlet backing surface 12 with the radially outer disc inlet portion 23 and with the radially inner disc inlet portion 22 of the disc inlet pad abutment surface 18, the brake pad 3, 3′ faces the disc outlet backing surface 13 with the disc outlet pad abutment surface 19 without contact, discharging the braking action tangentially at least against the disc inlet backing surface 12.

In an embodiment, during a braking action in reverse motion, the brake pad 3, 3′, from the resting configuration to the reverse braking configuration, rotates about the support pin 10, 10′, sliding at least along the tangential direction T-T with the pin seat 20 abutting against the support pin 10, 10′, and rotates with respect to the disc inlet radially outer portion 23 sliding along the radial direction R-R, in the opposite direction to the brake disc 5, with the disc inlet radially outer portion 23 abutting against the disc inlet backing surface 12, until the disc inlet radially inner portion 22 comes into tangential abutment against the disc inlet backing surface 12.

In an embodiment, during a braking action in reverse motion, the brake pad 3, 3′, from the resting configuration to the reverse motion braking configuration, follows a roto-translation trajectory, rotating about the support pin 10, 10′ and sliding tangentially on the support pin 10, 10′ and radially on the disc inlet backing surface 12.

In an embodiment, during a braking action in forward motion, the brake pad 3, 3′, from the resting configuration to the reverse braking configuration, rotates about the support pin 10, 10′, sliding at least along the tangential direction T-T with the pin seat 20 abutting against the support pin 10, 10′, and rotates with respect to the disc outlet radially inner portion 24 sliding along the radial direction R-R, towards the brake disc 5, with the disc outlet radially inner portion 24 abutting against the disc outlet backing surface 13, until the disc outlet radially outer portion 25 comes into tangential abutment against the disc outlet backing surface 13.

In an embodiment, during a braking action in forward motion, the brake pad 3, 3′, from the resting configuration to the forward motion braking configuration, follows a roto-translation trajectory, rotating about the support pin 10, 10′ and sliding tangentially on the support pin 10, 10′ and radially on the disc outlet backing surface 13.

In an embodiment, wherein the pin seat 20 comprises a support surface 21, wherein the support surface 21 is configured to slide to abut against the support pin 10, 10′.

In an embodiment, the support surface 21, when the brake pad is in the resting configuration, in a plane perpendicular to the axial direction A-A, is parallel to the tangential direction T-T.

In an embodiment, the pin seat 20 comprises a support surface 21.

In an embodiment, the support surface 21 is configured to slide to abut against the support pin 10, 10′.

In an embodiment, the support surface 21, when the brake pad is in the resting configuration, in a plane perpendicular to the axial direction A-A, is inclined with respect to the tangential direction T-T or to a direction parallel thereto by a support angle ALFA.

In an embodiment, the support angle ALFA is comprised between 0 degrees and 60 degrees. In an embodiment, the support angle ALFA is comprised between 0 degrees and 55 degrees. In an embodiment, the support angle ALFA is comprised between 10 degrees and 60 degrees. In an embodiment, the support angle ALFA is comprised between 10 degrees and 55 degrees. In an embodiment, the support angle ALFA is comprised between 10 degrees and 40 degrees. In an embodiment, the support angle ALFA is comprised between 10 degrees and 30 degrees. In an embodiment, the support angle ALFA is comprised between 20 degrees and 30 degrees.

By virtue of the orientation of the pin seat and of the support surface of the pin seat, against which the brake pad abuts while rotating and sliding on the support pin, it is possible to bias the rotational moment of the brake pad about the radial direction, and to balance any tendencies of the brake pad to skew, by modulating the tangential braking force that is discharged onto the pin, within the limits of mechanical resistance of the support pin.

By virtue of the orientation of the pin seat and of the support surface of the pin seat, against which the brake pad abuts while rotating and sliding on the support pin, the axial imbalance generated by the tangential position of the pin seat is reduced, reducing or eliminating the residual torque. By virtue of the orientation of the pin seat and of the support surface of the pin seat, with which the brake pad abuts against the support pin, the contact forces against the disc outlet backing surface and the disc inlet backing surface are made to vary, which may form planar supports. By virtue of the orientation of the pin seat and of the support surface of the pin seat with which the brake pad abuts against the support pin, it is possible to reduce the imbalance between the axial forces of the springs generated by different arms, or different pin distances D1-D2, with respect to the tangential position of the pin seat, reducing or eliminating the residual torque.

In an embodiment, the support surface 21 is flat.

In an embodiment, the support surface 21 avoids comprising curved portions, e.g., avoiding comprising cylindrical portions.

In an embodiment, the plate edge 15 comprises the support surface 21, which extends between the first plate face 16 and the second plate face 17.

In an embodiment, the support surface 21 faces along the radial direction R-R toward the brake disc 5, namely in a radially inner direction.

In an embodiment, the pin seat 20 is in a portion of the plate 17 radially on the opposite side with respect to the brake disc 5.

In an embodiment, the pin seat 20 is a through-slot across the thickness of the plate 7 along the axial direction A-A, which forms a closed profile in a plane perpendicular to the axial direction A-A.

In an embodiment, the pin seat 20 forms a recess delimited by the plate edge 15 along the radial direction R-R, both radially inward and radially outward, i.e., both in the direction of moving towards the brake disc 5 and in the direction of moving away from the brake disc, and delimited by the plate edge 15 on one tangential part, leaving it at least partially open on the opposite tangential part, e.g., it is tangentially closed toward the disc outlet abutment surface 19 and is at least partially tangentially open toward the disc inlet abutment surface 18, and is open along the axial direction A-A to receive the support pin 10, 10′.

In an embodiment, the pin seat 20 is shaped to receive the support pin 10, 10′ with clearance so as to allow the support surface 21 to slide on the support pin 10, 10′ at least along the axial direction A-A, and to circumferentially slide on the support pin 10, 10′, rotating about the support pin 10, 10′.

In an embodiment, the brake pad 3, 3′ defines a midplane perpendicular to the tangential direction, with respect to which the disc outlet abutment surface 19 and the disc inlet abutment surface 18 are arranged symmetrically.

In an embodiment, the pin seat 20 is tangentially closer to the disc outlet abutment surface 19 than to the disc inlet abutment surface 18, e.g., avoiding being arranged in a position crossed by the midplane of the brake pad.

In an embodiment, the pin seat 20 is arranged tangentially, in a view perpendicular to the axial direction A-A, closer to the midplane than the disc outlet abutment surface 19.

In an embodiment, the pin seat 20 is arranged tangentially, in a view perpendicular to the axial direction A-A, at a distance from the disc outlet abutment surface 19 equal to at least one half of the distance between the midplane and the disc outlet abutment surface 19, and at a distance from the midplane equal to at least one fourth of the distance between the midplane and the disc outlet abutment surface 19.

By virtue of the tangential arrangement of the pin seat between the disc outlet abutment surface and the midplane of the pad, avoiding arranging the pin seat near, or closer to, the disc outlet abutment surface, it is possible to modulate the friction forces between the brake pad and the fixed portion, e.g., the caliper body or the support bracket, guaranteeing the sliding of the brake pad upon cessation of the braking force in retraction, by means of the elastic return of the pad return device. By virtue of the tangential arrangement of the pin seat between the disc outlet abutment surface and the pad midplane, avoiding arranging the pin seat at the pad midplane, it is possible to prevent vibrations during driving from setting the brake pad into oscillation, generating rattling noises.

By virtue of the tangential arrangement of the pin seat between the disc outlet abutment surface and the pad midplane, avoiding arranging the pin seat near, or closer to, the disc outlet abutment surface and arranging it closer to the pad midplane, it is possible to modulate the rotational moment of the brake pad about the radial direction, avoiding skewing of the brake pad during retraction, which would generate residual braking torque upon cessation of the braking action.

In an embodiment, the disc outlet abutment surface 19 and the disc inlet abutment surface 18 are flat surfaces, perpendicular to the tangential direction T-T.

In an embodiment, the disc inlet backing surface 12 and the disc outlet backing surface 13 are flat surfaces, perpendicular to the tangential direction T-T.

In an embodiment, wherein the support surface 21 is parallel to the axial direction A-A.

In an embodiment, the retaining spring 4 comprises at least one coupling portion 28, wherein the connecting portion 28 is configured to connect to the fixed portion 2, e.g. the caliper body or the reinforcement bracket. For example, connecting portion 28 is configured to a central bridge of the caliper body or interposing between a central bridge of the caliper body and a side bridge of the caliper body, to bias the brake pad without contacting the support pin 10, 10′.

In an embodiment, the retaining spring 4 comprises at least one thrust portion 29.

In an embodiment, each thrust portion 29 is configured to constantly elastically bias the brake pad 3, 3′ and/or the plate 7 and/or the plate edge 15 at least along a direction coincident with or parallel to the radial direction R-R.

In an embodiment, each thrust portion 29 is configured to elastically and constantly bias the brake pad 3, 3′ and/or the plate 7 and/or the plate edge 15 at least along a direction either coincident with or parallel to the radial direction R-R, without preventing the sliding of the brake pad 3, 3′ along the axial direction A-A or a direction parallel thereto during the braking action, without preventing the sliding of the brake pad 3, 3′ along the tangential T-T or a direction parallel thereto during the braking action.

In an embodiment, the retaining spring 4 is a band spring.

In an embodiment, the pad return device 9 is a spring, e.g., a band spring.

In an embodiment, the brake caliper 1 comprises a pad spring 27. In an embodiment, the pad spring is a band spring.

In an embodiment, the pad spring 27 comprises the pad return device 9 and the retaining spring 4.

In an embodiment, each portion 29 is configured to constantly elastically bias the brake pad 3, 3′ and/or the plate 7 and/or the plate edge 15 at least along a direction either coincident with or parallel to the radial direction R-R and at least along a direction coincident with or parallel to the axial direction A-A, biasing the brake pad 3, 3′ to radially abut against the support pin 10, 10′ and axially away from the brake disc 5.

In an embodiment, the at least one thrust portion 29, 29′ comprises a first thrust portion 29 and a second thrust portion 29′ connected to the fixed portion 2, e.g. the brake caliper or the support bracket, so as to bias the brake pad 3, 3′ to abut with the plate 7 of the brake pad 3, 3′ from tangentially opposite sides with respect to the support pin 10, 10′, at a first thrust distance D1 from the support pin 10, 10′ towards the disc inlet abutment surface 18 and at a second thrust distance D2 from the support pin 10, 10′ towards the disc outlet abutment surface 19, respectively, wherein the first thrust distance D1 and the second thrust distance D2 are defined in a plane perpendicular to the axial direction A-A and/or to the pin axis E, E′, wherein the first thrust distance D1 is greater than the second thrust distance D2 so as to elastically bias the brake pad to the resting configuration. In an embodiment, the first thrust distance D1 is between three and four times the second thrust distance D2.

In an embodiment, the plate edge 15 comprises at least one abutment portion 26, 26′.

In an embodiment, the retaining spring 4 biases the pad plate 7 on at least the backing portion 26, 26′ which is at the thrust distance D1, D2 with respect to the pin axis E, E′ of the support pin 10, 10′ so as to constantly bias the brake pad 3, 3′ in rotation about the pin axis E, E′ of the support pin 10, 10′ towards a resting configuration.

In an embodiment, the abutment portion 26, 26′ is an edge of the plate edge 15.

In an embodiment, the abutment portion 26, 26′ is a tapered surface with respect to the axial direction A-A tapering from the second plate face 17 to the first plate face 16.

In an embodiment, the backing portion 26, 26′ is a convex surface facing in an outer radial direction, on the side opposite the brake disc 5, which tapers symmetrically, in planes perpendicular to the axial direction A-A, from tangentially opposite sides with respect to an apical zone.

In an embodiment, the at least one abutment portion 26, 26′ comprises a first abutment portion 26 and a second abutment portion 26′, wherein the retaining spring 4 biases the pad plate 7 against the first abutment portion 26 and the second abutment portion 26′, which are, respectively, at the first thrust distance D1 and at the second thrust distance D2 with respect to the pin axis E, E′ of the support pin 10, 10′ so as to constantly bias the brake pad 3, 3′ rotatably about the pin axis E, E′ of the support pin 10, 10′ toward the resting configuration.

In an embodiment, the first thrust portion 29 and the second thrust portion 29′ bias the pad plate 7, respectively, into contact with the first backing portion 26 and with the second backing portion 26′, which are respectively at the first thrust distance D1 and at the second thrust distance D2 with respect to the pin axis E, E′ of the support pin 10, 10′, so as to constantly bias the brake pad 3, 3′ in rotation with respect to around the pin axis E, E′ of the support pin 10, 10′ towards the resting configuration.

In an embodiment, the brake pad 3, 3′ comprises a midplane perpendicular to the tangential direction T-T, wherein the first backing portion 26 and the second backing portion 26′ are symmetric with respect to the midplane.

In an embodiment, the brake caliper 1 and/or the at least one retaining spring comprises a first retaining spring 4 and a second retaining spring 4′ made in separate pieces, wherein the first retaining spring 4 comprises the first thrust portion 29 and the second retaining spring 4′ comprises the second thrust portion 29′. In an embodiment, the brake caliper 1 and/or the at least one retaining spring comprises a first retaining spring 4 and a second retaining spring 4′ made in one piece, wherein the first retaining spring 4 comprises the first thrust portion 29 and the second retaining spring 4′ comprises the second thrust portion 29′.

In an embodiment, the brake caliper 1 defines a symmetry plane perpendicular to the axial direction A-A.

In an embodiment, the brake caliper 1 comprising a first brake pad 3 and a second brake pad 3′ supported by a first support pin 10 and a second support pin 10′, wherein the first support pin 10 and the second support pin 10′ axially face each other and have the respective pin axes E, E′ aligned along the same direction parallel to the axial direction A-A.

In an embodiment, the first brake pad 3 and the first support pin 10 are symmetrical, with respect to the symmetry plane, to the second brake pad 3′ and the second support pin 10′.

In an embodiment, the retaining spring 4 and the pad return device 9 are symmetrical with respect to the symmetry plane, so as to elastically bias the first brake pad 3 and the second brake pad 3′ from axially opposite sides with respect to the brake disc 5.

The present invention also relates to a disc brake comprising a brake caliper 1 according to any one of the embodiments previously described, and a brake disc 5, wherein, wherein during a braking action, in forward travel or in reverse travel, the at least one brake pad 3, 3′ is configured to slide in the axial direction A-A either directly or indirectly under the thrust of the at least one thrust device 11, toward the brake disc against the axial elastic bias of the pad return device 9, maintaining the resting configuration under the radial elastic action of the retaining spring 4, until contacting the brake disc 5, wherein when the at least one brake pad 3, 3′ in the resting configuration contacts the brake disc 5 under the direct or indirect thrust of the at least one thrust device 11, at least one brake pad 3, 3′ is configured to be dragged by the brake disc 5 in tangential direction toward the braking configuration in forward travel or the braking configuration in reverse travel.

By virtue of the suggested solutions, it is possible to reduce or even eliminate clang noises, rattling noises and any residual torques between the brake pad and the brake disc once the braking action has ended.

Furthermore, by virtue of the suggested solutions, it is possible to reduce vibrations and impacts of the brake pad against other components of the brake caliper.

By virtue of the suggested solutions, with a roto-translation of the brake pad on two constraints, the support pin on which the pad slides and rotates and the disc outlet side backing surface or the disc inlet side surface on which the pad slides in the radial direction, the brake pad is gradually brought into tangential abutment without losing contact with the support pin, and it is thus possible to avoid knocking and clang noises of the brake pad during the braking action, which would be generated with a motion of pure rotation of the pad.

Furthermore, by virtue of the suggested solutions, it is possible to avoid premature wear of the brake pad, the brake pad being spaced from the brake disc in the absence of the braking action.

By virtue of the suggested solutions, according to an aspect, it is possible to address the need to facilitate the retraction of the brake pads from the disc, without modifying the known retaining springs and the known pad return devices, but by providing, as a constraint in the radial direction for the brake pad, a single support pin, positioned so that, under the action of the retaining spring, the brake pad is biased in rotation toward the resting configuration into a triple abutment at three points or contact zones, namely against the support pin at least radially at a first zone or point of contact, and, on tangentially opposite sides, against the fixed portion, e.g. the caliper body or the support bracket, at a second zone or point of contact and a third zone or point of contact, which are misaligned with respect to the radial direction, so as to prevent clang noises during the movement of the brake pad during braking actions.

### LIST OF REFERENCES

1 brake caliper
2 fixed portion, e.g., caliper body or support bracket or caliper carrier
3 brake pad, first brake pad
3′ brake pad, second brake pad
4 retaining spring
5 brake disc
6 braking surface
7 pad plate
8 pad friction material
9 pad return device or pad return spring or axial spring
10 pad support pin, first brake pad support pin
10′ pad support pin, second brake pad support pin
11 thrust device, or thrust piston
12 disc inlet backing surface
13 disc outlet backing surface
15 plate edge
16 first plate face
17 second plate face
18 disc inlet abutment surface
19 disc outlet abutment surface
20 pin seat
21 support portion or support surface
22 radially inner disc inlet portion
23 radially outer disc inlet portion
24 radially inner disc outlet portion
25 radially outer disc outlet portion
26 backing portion, first backing portion
26′ backing portion, second backing portion
27 pad spring
28 coupling portion
29 thrust portion, first thrust portion
29′ second thrust portion
A-A axial direction
R-R radial direction
T-T tangential direction
X-X rotation axis
E pin axis, first pin axis
E′ pin axis, second pin axis
D1 thrust distance, first thrust distance
D2 thrust distance, second thrust distance

1. A brake caliper (1) for a disc brake,
wherein said brake caliper (1) defines an axial direction (A-A), a radial direction (R-R) perpendicular to the axial direction (A-A), and a tangential direction (T-T), perpendicular to both said axial direction (A-A) and said radial direction (R-R),
wherein the brake caliper (1) comprises a fixed portion (2),
wherein the fixed portion (2) is configured to be arranged straddling a brake disc (5), wherein said brake disc (5) has a rotation axis (X-X) about which it rotates, wherein the axial direction (A-A) is parallel to the rotation axis (X-X), wherein the radial direction (R-R) is perpendicular to the rotation axis (X-X),
wherein the brake caliper (1) comprises at least one brake pad (3, 3′),
wherein the brake caliper (1) comprises at least one support pin (10, 10′),
wherein the support pin (10, 10′) is mounted on the fixed portion (2) along a direction parallel to the axial direction (A-A), wherein each support pin (10, 10′) has a respective pin axis (E, E′), parallel to the axial direction (A-A),
wherein the brake caliper (1) comprises at least one retaining spring (4),
wherein the retaining spring (4) is connected to the fixed portion (2), wherein the retaining spring (4) is interposed between the fixed portion (2) and the at least one brake pad (3, 3′) to elastically bias, at least radially along a direction parallel to the radial direction (R-R) with a radial elastic bias, the at least one brake pad (3, 3′) to abut against the at least one support pin (10, 10′),
wherein the fixed portion (2) comprises a disc inlet backing surface (12) and a disc outlet backing surface (13) on tangentially opposite sides along the tangential direction (T-T),
wherein the at least one brake pad (3, 3′) comprises a plate (7) and a pad friction material (8) supported by the plate (7), wherein the friction material (8, 8′) is configured to abut against the brake disc (5) to apply a braking action to the brake disc (5);
wherein the plate (7) comprises a plate edge (15) delimiting the plate (7) between a first plate face (16) and a second plate face (17) axially opposite to each other along the axial direction (A-A),
wherein the plate edge (15) comprises a disc inlet pad abutment surface (18) and a disc outlet pad abutment surface (19) on tangentially opposite sides along the tangential direction (T-T),
wherein the disc inlet pad abutment surface (18) comprises a radially inner disc inlet portion (22) and a radially outer disc inlet portion (23),
wherein the disc outlet pad abutment surface (19) comprises a radially inner disc outlet portion (24) and a radially outer disc outlet portion (25),
wherein the plate edge (15) comprises a pin seat (20), wherein the pin seat (20) abuts against the support pin (10, 10′) at least along a direction parallel to the radial direction (R-R) against the radial elastic bias of the at least one retaining spring (4),
wherein the retaining spring (4) biases the plate edge (15) at a thrust distance (D1, D2) with respect to the pin axis (E, E′) of the support pin (10, 10′) so as to constantly bias the brake pad (3, 3′) in rotation about the pin axis (E, E′) of the support pin (10, 10′) towards a resting configuration,
wherein, in the resting configuration, the brake pad (3, 3′) abuts with the pin seat (20) at least along the radial direction (R-R) against the support pin (10, 10′), and the brake pad (3, 3′) abuts at least along the tangential direction (T-T) on one side against the disc outlet backing surface (13) with the radially inner disc outlet portion (24) of the disc outlet pad abutment surface (19), and on the opposite side against the disc inlet backing surface (12) with the radially outer disc inlet portion (23) of the disc inlet pad abutment surface (18), or vice versa,
wherein the at least one brake pad (3, 3′) is supported along the radial direction (R-R) or directions parallel thereto by only one of said at least one support pin (10, 10′),
wherein the brake caliper (1) comprises a pad return device (9),
wherein the pad return device (9) is configured to constantly elastically bias the brake pad (3, 3′) at least along the axial direction (A-A) or directions parallel thereto, with opposite orientation with respect to the brake disc (5),
wherein during a braking action, in forward travel, the brake pad (3, 3′) is configured to be dragged by the brake disc (5) from the resting configuration to a forward travel braking configuration,
wherein in the forward motion braking configuration, the brake pad (3, 3′) abuts against the support pin (10, 10′) at least along the radial direction (R-R), the brake pad (3, 3′) abuts along the tangential direction (T-T) against the disc outlet backing surface (13) with the radially inner disc outlet portion (24) and with the radially outer disc outlet portion (25) of the disc outlet pad abutment surface (19), the brake pad (3, 3′) faces the disc inlet backing surface (12) with the disc inlet pad abutment surface (18) without contact, discharging the braking action tangentially at least against the disc outlet backing surface (13).

2. The brake caliper of claim 1,
wherein the retaining spring (4) is interposed between the fixed portion (2) and the at least one brake pad (3, 3′) without contacting the support pin (10, 10′).

3. The brake caliper of claim 1,
wherein during a braking action, in reverse travel, the brake pad (3, 3′) is configured to be dragged by the brake disc (5) from the resting configuration to a reverse travel braking configuration,
wherein in the reverse motion braking configuration, the brake pad (3, 3′) abuts against the support pin (10, 10′) at least along the radial direction (R-R), the brake pad (3, 3′) abuts along the tangential direction (T-T) against the disc inlet backing surface (12) with the radially outer disc inlet portion (23) and with the radially inner disc inlet portion (22) of the disc inlet pad abutment surface (18), the brake pad (3, 3′) faces the disc outlet backing surface (13) with the disc outlet pad abutment surface (19) without contact, discharging the braking action tangentially at least against the disc inlet backing surface (12).

4. The brake caliper of claim 1, wherein from the resting configuration to a reverse motion braking configuration, the brake pad (3, 3′) is configured to rotate against the radial elastic bias of the retaining spring (4) about the support pin (10, 10′) and the brake pad (3, 3′) is configured to translate at least along the tangential direction (T-T) sliding on the support pin (10, 10) and along the radial direction (R-R) sliding on the disc inlet backing surface (12), and/or wherein, during a braking action in reverse motion, from the resting configuration to the reverse motion braking configuration, the brake pad (3, 3′) is configured to rotate about the support pin (10, 10′), sliding at least along the tangential direction (T-T) with the pin seat (20) abutting against the support pin (10, 10′), and to rotate with respect to the radially outer disc inlet portion (23) sliding along the radial direction (R-R), with opposite orientation with respect to the brake disc (5), with the radially outer disc inlet portion (23) abutting against the disc inlet backing surface (12), until the radially inner disc inlet portion (22) tangentially abuts against the disc inlet backing surface (12), and/or wherein during a braking action in reverse motion, the brake pad (3, 3′), from the resting configuration to the reverse motion braking configuration, follows a roto-translation trajectory, rotating about the support pin (10, 10′) and sliding tangentially on the support pin (10, 10′) and radially on the disc inlet backing surface (12).

5. The brake caliper of claim 1, wherein from the resting configuration to a forward motion braking configuration, the brake pad (3, 3′) is configured to rotate against the radial elastic bias of the retaining spring (4) about the support pin (10, 10′) and the brake pad (3, 3′) is configured to translate at least along the tangential direction (T-T) sliding on the support pin (10, 10′) and along the radial direction (R-R) sliding on the disc outlet backing surface (13), and/or
wherein during a braking action in forward motion, from the resting configuration to a forward motion braking configuration, the brake pad (3, 3′) is configured to rotate about the support pin (20′), sliding at least along the tangential direction (T-T) with the pin seat (10, 10) abutting against the support pin (3, 3′), and the brake pad (10, 10′) is configured to rotate with respect to the radially inner disc outlet portion (24) sliding along the radial direction (R-R), towards the brake disc (5), with the radially inner disc outlet portion (24) abutting against the disc outlet backing surface (13), until the radially outer disc outlet portion (25) tangentially abuts against the disc outlet backing surface (13), and/or wherein during a braking action in forward motion, the brake pad (3, 3′), from the resting configuration to the forward motion braking configuration, follows a roto-translation trajectory, rotating about the support pin (10, 10′) and sliding tangentially on the support pin (10, 10′) and radially on the disc outlet backing surface (13).

6. The brake caliper of claim 1,
wherein the pin seat (20) comprises a support surface (21), wherein the support surface (21) is configured to slide to abut against the support pin (10, 10′),
wherein the support surface (21), when the brake pad is in the resting configuration, in a plane perpendicular to the axial direction (A-A), is parallel to the tangential direction (T-T).

7. The brake caliper of claim 1,
wherein the pin seat (20) comprises a support surface (21), wherein the support surface (21) is configured to slide to abut against the support pin (10, 10′),
wherein the support surface (21), when the brake pad is in the resting configuration, in a plane perpendicular to the axial direction (A-A), is inclined with respect to the tangential direction (T-T) or to a direction parallel thereto by a support angle (ALPHA).

8. The brake caliper of claim 7, wherein the support angle (ALPHA) is between 0 degrees and 60 degrees, preferably between 20 degrees and 30 degrees.

9. The brake caliper of claim 8, wherein the support surface (21) is flat,
and/or wherein the support surface (21) avoids comprising curved portions, for example avoiding comprising cylindrical portions.

10. The brake caliper of claim 1,
wherein the retaining spring (4) comprises at least one coupling portion (28), wherein the connecting portion (28) is configured to connect to the fixed portion (2), to bias the brake pad without contacting the support pin (10, 10′),
wherein the retaining spring (4) comprises at least one thrust portion (29),
wherein each thrust portion (29) is configured to constantly elastically bias the brake pad (3, 3′) at least along a direction coincident with or parallel to the radial direction (R-R).

11. The brake caliper of claim 10,
wherein the pad return device (9) is a spring,
wherein the brake caliper (1) comprises a pad spring (27),
wherein the pad spring (27) comprises the pad return device (9) and the retaining spring (4),
wherein each portion (29) is configured to constantly elastically bias the brake pad (3, 3′) at least along a direction coincident with or parallel to the radial direction (R-R) and at least along a direction coincident with or parallel to the axial direction (A-A), biasing the brake pad (3, 3′) to radially abut against the support pin (10, 10′) and axially away from the brake disc (5).

12. The brake caliper of claim 11,
wherein the at least one thrust portion (29, 29′) comprises a first thrust portion (29) and a second thrust portion (29′) connected to the fixed portion (2) so as to bias the brake pad (3, 3′) to abut with the plate (7) of the brake pad (3, 3′) from tangentially opposite sides with respect to the support pin (10, 10′), at a first thrust distance (D1) from the support pin (10, 10′) towards the disc inlet abutment surface (18) and at a second thrust distance (D2) from the support pin (10, 10′) towards the disc outlet abutment surface (19), respectively, wherein the first thrust distance (D1) and the second thrust distance (D2) are defined in a plane perpendicular to the axial direction (A-A) and/or to the pin axis (E, E′), wherein the first thrust distance (D1) is greater than the second thrust distance (D2) so as to elastically bias the brake pad to the resting configuration.

13. The brake caliper of claim 12, wherein the brake caliper (1) and/or the at least one retaining spring comprises a first retaining spring (4) and a second retaining spring (4′) made in separate pieces, wherein the first retaining spring (4) comprises the first thrust portion (29) and the second retaining spring (4′) comprises the second thrust portion (29′).

14. The brake caliper of claim 1,
wherein the brake caliper (1) defines a symmetry plane perpendicular to the axial direction (A-A),
wherein the brake caliper (1) comprising a first brake pad (3) and a second brake pad (3′) supported by a first support pin (10) and a second support pin (10′), wherein the first support pin (10) and the second support pin (10′) axially face each other and have the respective pin axes (E, E′) aligned along the same direction parallel to the axial direction (A-A),
wherein the first brake pad (3) and the first support pin (10) are symmetrical, with respect to the symmetry plane, to the second brake pad (3′) and the second support pin (10′),
wherein the retaining spring (4) and the pad return device (9) are symmetrical with respect to the symmetry plane, so as to elastically bias the first brake pad (3) and the second brake pad (3′) from axially opposite sides with respect to the brake disc (5).
